(19) United States
(12) Patent Application Publication
(10) Pub. No.: US 2011/0199478 A1
(43) Pub. Date: Aug. 18, 2011

(54) INSPECTION SYSTEM AND INSPECTION METHOD, MANAGEMENT SERVER, MOBILE TERMINAL, INSPECTION PROGRAM AND MEMORY MEDIUM

(75) Inventor: Atsushi ITO, Tokyo (JP)

(73) Assignee: FUJIFILM Corporation, Tokyo (JP)

(21) Appl. No.: 12/978,132

(22) Filed: Dec. 23, 2010

(30) Foreign Application Priority Data
Feb. 17, 2010 (JP) 2010-032675

(51) Int. Cl. H04N 7/18

(52) U.S. Cl. 348/92; 348/E07.085

(57) ABSTRACT

An inspection program which is installed on a mobile terminal connects to a management server via a communication network and acquires inspection identifying information. The mobile terminal captures inspection subject picture of an inspection site corresponding to the inspection identifying information and inspection backup picture for backing up the inspection subject picture. The inspection program creates inspection information to associate image data of inspection subject picture and image data of inspection backup picture with the inspection identifying information. The inspection information, the image data of inspection subject picture and the image data of inspection backup picture are merged, and a hash value is calculated by a hash function based on the merged result. The hash value, the inspection information, the image data of inspection subject picture and the image data of inspection backup picture are sent to the management sever all together. Based on the hash value, it is judged whether the image data is tampered or not.

### BACKGROUND OF THE INVENTION

1. Field of the Invention

The present invention relates to an inspection system management server which performs inspections, such as a construction inspection, using a mobile terminal, the mobile terminal, an inspection program and a memory medium.

2. Description of the Related Art

In the conventional bar arrangement inspection, a report is made using a blackboard on which location where the picture was taken (shooting point), section reference and picture number are written, and verification pictures of the bar arrangement at the construction site (in-process pictures). Since quite a number, like several hundreds, of verification pictures are used for the inspection, their management is troublesome. In view of this, there is known an image data management method in which verification pictures are associated with photographing information or photographed subject identifying information to be stored in a specified folder on a management server via internet, and the above-mentioned report is made using the verification pictures stored on the server (Japanese Patent Laid-Open Publication No. 2005-197901).

In the bar arrangement inspection, the verification pictures need to be taken for 3 times during the process in chronological order. However, there may be a possibility that the verification pictures taken at the time of the first shoot are altered or tampered and fraudulently used as verification pictures for other 2 times. In view of this, there is a request from clients to confirm the authenticity of the report.

According to the image data management method described in the Japanese Patent Laid-Open Publication No. 2005-197901, the photographing information including at least one of the photographed location information, time and came model ID is added to the image data by means of digital watermark so as to prevent tampering.

In addition, to prevent image data tampering, there is a photographing certificate system, a photographing device, a certificate device, and a photographing certificate method (Japanese Patent Laid-Open Publication No. 2003-152712) in which a hash value is calculated from image data using a preliminary determined hash function, and the image data and the hash value are stored in the management server. When the image data is used, a current hash value is calculated using the hash function again, thereby judging whether the image data was tampered by comparing the current hash value with the hash value stored in the management server.

According to the invention disclosed in the Japanese Patent Laid-Open Publication No. 2003-152712, it can be found that the original pictures are tampered or not. However, it is impossible to find out if the original verification pictures themselves are fraudulent pictures like being misappropriated from other construction sites or not. In addition, according to the invention disclosed in the Japanese Patent Laid-Open Publication No. 2005-197901, the information added by means of digital watermark includes GPS location information. However, the construction site is often located in a basement or upper floor where the GPS information cannot be obtained, and therefore the GPS information cannot practically be used to prevent fraud.

### SUMMARY OF THE INVENTION

In view of the foregoing problems, an object of the present invention is to provide an inspection system and an inspection method, a management server, a mobile terminal, an inspection program, and a memory device which can detect fraud of original verification pictures, without using GPS information.

In order to achieve the above objects and other objects, an inspection system of the present invention includes a mobile terminal, a management server and a PC terminal. The mobile terminal has a photographing function. The management server stores image data received from the mobile terminal via communication network. The PC terminal performs an inspection based on the image data acquired from the management server.

The mobile terminal includes an inspection identifying information acquisition section, an image data acquisition section, an inspection information creating section, a hashing section, and a transmitting section. The inspection identifying information acquisition section acquires inspection identifying information preliminarily determined for each inspection site. The image data acquisition section acquires image data of inspection subject picture which is a picture of the inspection site corresponding to the inspection identifying information and image data of inspection backup picture which is a picture taken for backing up the inspection subject picture. The inspection information creating section creates inspection information which associates the image data of the inspection subject picture and the image data of the inspection backup picture with the inspection identifying information. The hashing section merges the inspection information, the image data of the inspection subject picture and the image data of the inspection backup picture, and calculates a first hash value by a hash function based on the merged result. The transmitting section transmits the first hash value, the inspection information, the image data of the inspection subject picture and the image data of the inspection backup picture to the management server.

The management server includes a storage section, a hash value calculating section, and a tampering judgment section. The storage section stores the first hash value, the inspection information, the image data of the inspection subject picture and the image data of the inspection backup picture in association with the inspection identifying information. The hash value calculating section merges the inspection information corresponding to the inspection identifying information, the image data of the inspection subject picture and the image data of the inspection backup picture, and calculates a second hash value by the hash function based on the merged result when the image data corresponding to the inspection identifying information is requested to be acquired from the PC terminal. The tampering judgment section judges existence of tempering by comparing the second hash value with the first hash value, and allows transmission of the image data when it is judged that there is no tampering.

The PC terminal includes a display section. The display section displays the image data of the inspection subject picture and the image data of the inspection backup picture acquired from the management server.

The management server may further include a memory section. The memory section creates a common key for each inspection identifying information, and stores the created common key in association with the inspection identifying information. In this case, the mobile terminal further includes a common key acquisition section for acquiring a common key corresponding to the inspection identifying information from the management server. Here, the hashing section of the mobile terminal merges the inspection information including the common key, the image data of the inspection subject picture and the image data of the inspection backup picture, and calculates the first hash value by the hash function based on the merged result. The hash value calculating section of the management server merges the inspection information corresponding to the inspection identifying information including the common key, the image data of the inspection subject picture and the image data of the inspection backup picture, and calculates the second hash value by the hash function based on the merged result.

A management server of the present invention includes a transmitting section, a receiving section, a storage section, a hash value calculating section, and a tampering judgment section. The transmitting section transmits the inspection identifying information upon request from a mobile terminal. The receiving section receives image data of inspection subject picture which is a picture of an inspection site corresponding to the inspection identifying information, image data of inspection backup picture which is a picture taken for backing up the inspection subject picture, inspection information which associates the image data of the inspection subject picture and the image data of the inspection backup picture, and a first hash value calculated by a hash function based on the merged result obtained by merging the inspection information, the image data of the inspection subject picture and the image data of the inspection backup picture from the mobile terminal. The storage section stores the first hash value, the inspection information, the image data of the inspection subject picture and the image data of the inspection backup picture in association with the inspection identifying information. The hash value calculating section merges the inspection information corresponding to the inspection identifying information, the image data of the inspection subject picture and the image data of the inspection backup picture, and calculates a second hash value by the hash function based on the merged result when the image data corresponding to the inspection identifying information is requested to be acquired from the PC terminal. The tampering judgment section judges existence of tempering by comparing the second hash value with the first hash value, and allows transmission of the image data when it is judged that there is no tampering.

A mobile terminal of the present invention includes a memory section, a communication section, an identifying information acquisition section, an image data acquisition section, an inspection information creating section, a hashing section, and a transmitting section. The memory section preliminarily stores connection destination information of the management server. The communication section is connected to the management server via the communication network. The identifying information acquisition section acquires inspection identifying information corresponding to an inspection site from a management server. The image data acquisition section acquires image data of inspection subject picture which is a picture of the inspection site corresponding to the inspection identifying information and image data of inspection backup picture which is a picture taken for backing up the inspection subject picture by activating the photographing function. The inspection information creating section creates inspection information which associates the image data of the inspection subject picture and the image data of the inspection backup picture with the inspection identifying information. The hashing section merges the inspection information, the image data of the inspection subject picture and the image data of the inspection backup picture, and calculates a first hash value by a hash function based on the merged result. The transmitting section transmits the first hash value, the inspection information, the image data of the inspection subject picture and the image data of the inspection backup picture to the management server.

It is possible that the management server acquires a common key corresponding to the inspection identifying information and calculates the second hash value based on the merged result including the common key.

According to the present invention, the image data of the inspection subject picture and the image data of the inspection backup picture are acquired at once during the operation by the mobile terminal and sent to the management server together. Owing to this, it is prevented that the fraudulent pictures are used as the inspection subject pictures. Moreover, since the inspection backup picture is also acquired at the time of acquiring the inspection subject picture using the mobile terminal, the credibility of the inspection subject picture can be checked by referring the inspection backup picture.

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating a schematic configuration of a bar arrangement inspection system;

FIG. 2 is an explanatory view illustrating a schematic configuration of a mobile phone;

FIG. 3 is an explanatory view illustrating a schematic configuration of a bar arrangement inspection program installed on the mobile terminal;

FIG. 4 is an explanatory view illustrating a schematic configuration of a management server;

FIG. 5 is an explanatory view illustrating a schematic configuration of a PC terminal;

FIG. 6 is a flowchart illustrating a process of the bar arrangement program installed on the mobile terminal;

FIG. 7 is an explanatory view illustrating a display screen of the mobile terminal on which a construction name is selected from a list;

FIG. 8 is an explanatory view illustrating a display screen of the mobile terminal on which a floor to be inspected is selected from a list;

FIG. 9 is an explanatory view illustrating a display screen of the mobile terminal on which an inspection area is selected;

FIG. 10 is an explanatory view illustrating a display screen of the mobile terminal on which a bar arrangement drawing corresponding to the designated inspection area is displayed;

FIG. 11 is an explanatory view illustrating a display screen of the mobile terminal when a camera section is activated;

FIG. 12 is an explanatory view schematically illustrating the contents of an inspection information file;

FIG. 13 is an explanatory view schematically illustrating that the inspection information file, a hash value information file, a common key information file and the image data are stored in the management server in association with inspection ID;

FIG. 14 is a flowchart illustrating an operation process of the management server when a request for acquiring image data of inspection subject picture is sent from the PC terminal; and

FIG. 15 is a flowchart illustrating a process of the PC terminal when producing a bar arrangement inspection report.

### DESCRIPTION OF THE PREFERRED EMBODIMENTS

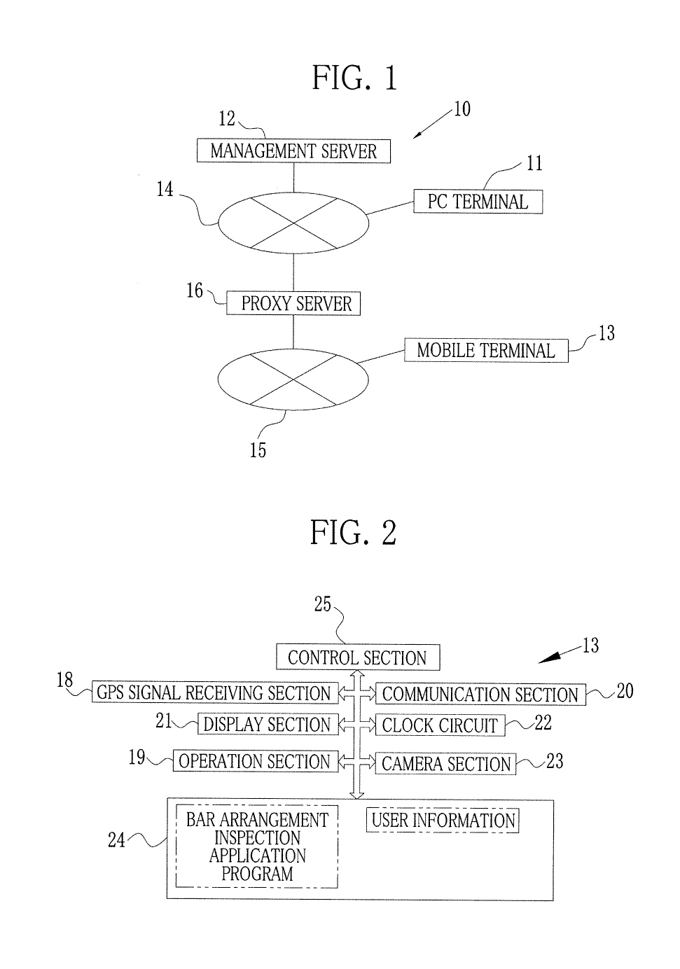

Hereinafter, a bar arrangement inspection system is explained as one embodiment of an inspection system of the present invention. As shown in FIG. 1, a bar arrangement inspection system 10 is composed of a personal computer (hereinafter, referred to as “PC terminal”) 11, a management server 12, and a mobile phone with camera (hereinafter, referred to as “mobile terminal) 13. The mobile terminal 13, which is carried by an inspector to a construction site, is connected to an internet network 14 through a proxy server 16 of a mobile phone company via a predetermined packet communication network 15 provided by the mobile phone company. The mobile terminal 13 thereby communicates with the external management server 12 which is connected to the internet network 14. Image data of verification pictures taken with the mobile terminal 13 is sent from the mobile terminal 13 to the management server 12 and stored in a specified folder in a memory section of the management server 12. The PC terminal 11 is connected to the internet network 14. A bar arrangement inspection report is made by a report writer (operator) using the PC terminal 11. When making the report, the image data of verification pictures to be attached to the report is downloaded from the management server 12. To the management server 12, a number of PC terminals 11 and the mobile terminals 13 are connected. Note that the PC terminal 11 may be connected to the management server 12 through an internal LAN. The internet network 14 and the packet communication network 15 are the communication network of the present invention.

As shown in FIG. 2, the mobile terminal 13 includes a GPS signal receiving section 18, an operation section 19 including a keypad, arrow keys and the like, a communication section 20, a display section 21, a clock circuit 22, a camera section 23, a memory section 24, and a control section 25. The control section 25 takes overall control of each component of the mobile terminal 13. The clock circuit 22 has a clock function and outputs data of year, month, date, and time. The camera section (photographing function) 23 includes a photographing lens and photographing sensors, and creates image data by capturing a subject image formed by the photographing lens.

The communication section 20 is connected to the internet network 14 through the packet communication network 15, and thereby communicating with the external management server 12. User information, which is used at the time of being connected to the proxy server 16 of the mobile phone company, is stored in the memory section 24.

A bar arrangement inspection application program (hereinafter, referred to as “bar arrangement inspection application”), which is activated at the time of executing an inspection of bar arrangement, is installed on the mobile terminal 13. In the memory section 24, files of the installed bar arrangement inspection application, the user information of the mobile terminal 13, and the like are stored. In addition, the memory section 24 is used as a memory for the control section 25, and also used as a cache memory to temporarily store the data sent from the management server 12.

Besides taking overall control of each component of the mobile terminal 13, the control section 25 has an execution section, a display control section, and the like. The execution section reads out and executes the above-described program in response to an instruction to execute the application program from the operation section 19, and the display control section displays the execution result on the display section 21.

The GPS signal receiving section 18 includes a GPS antenna and receives GPS signals from GPS satellites. The control section 25 calculates position using the GPS signals received from the GPS signal receiving section 18 at regular intervals, and outputs location information of the mobile terminal 13.

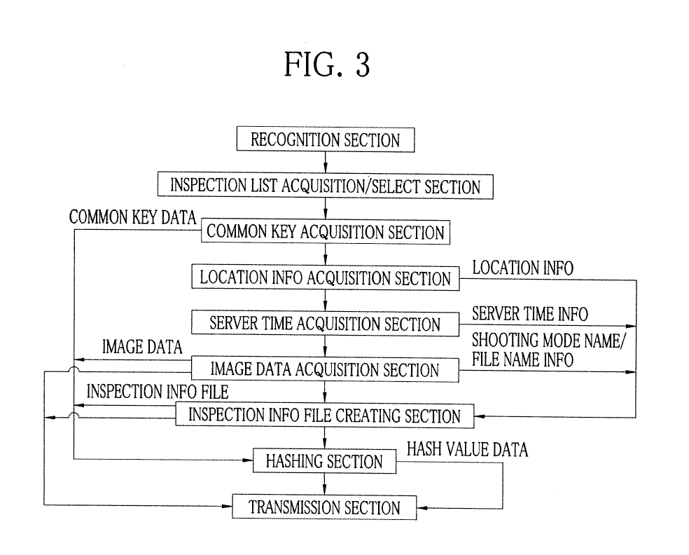

As shown in FIG. 3, the bar arrangement inspection application is a program which makes the control section 25 function as a recognition section, a common key acquisition section, an inspection list acquisition/select section, an image data acquisition section, an inspection information file creating section, a hashing section, a server time acquisition section, a location information acquisition section, and a transmission section. The program has a memory section to preliminarily store connection destination information of the management server 12.

The recognition section connects to the management server 12 and logs in to the management server 12. The inspection list acquisition/select section acquires list of inspection points from the management server 12, and allows selection of the inspection point. After the inspection point is selected, the common key acquisition section acquires a common key which has been created for each inspection point by the management server 12. The location information acquisition section requests the GPS signal receiving section 18 via the control section 25 for acquisition of the location information. The server time acquisition section acquires time of the management server 12 to confirm time lag.

After the inspection point is selected, the image data acquisition section acquires image data, which is captured by activating the camera section 23, in association with the inspection point. In the bar arrangement inspection application, two kinds of image data, one for inspection subject picture and the other for inspection backup picture, are acquired together in association with the inspection point during the operation of the application. Therefore, one of shooting modes between an inspection subject shooting mode and an inspection backup shooting mode is selected at the time of shooting pictures. The inspection subject shooting mode is selected to acquire image data of inspection subject picture to be used for verification picture. The inspection backup shooting mode is selected to acquire image data of inspection backup picture for confirming authenticity of the verification picture. The image data acquired under the inspection subject shooting mode is stored as the image data of inspection subject picture, while the image data acquired under the inspection backup shooting mode is stored as the image data of inspection backup picture separately. Note that the inspection subject picture captures the inspection point, for example, the arrangement of column reinforcement, and the blackboard on which information about the inspection point is written. The inspection backup picture captures, for example, surroundings of the inspection point, panoramic view of the construction site, face of the photographer, or the like, and is used for confirming the authenticity of the inspection subject picture.

The inspection information file creating section creates an inspection information file. In the inspection information file, information which associates the acquired image data with the inspection point is recorded. The recorded information includes information about the inspection point (inspection ID), GPS information, synchronized time with the management server, starting time of the bar arrangement inspection application (inspection start time), termination time of the bar arrangement inspection application (inspection end time), and shooting mode, shooting date and file name of the image data.

In order to ensure the safety of the acquired image data, the hashing section merges the image data, the inspection information file and the common key, and performs calculation by a one-way hash function based on the merged result, and thereby creating a hash value which is represented by a string of characters of predetermined length. The transmission section sends the acquired image data, the inspection information file and the hash value all together to the management server 12.

As shown in FIG. 4, the management server 12 includes a clock circuit 27, a communication section 28, a recognition section 29, a common key creating section 30, a hashing section 31, a memory section 32, a tampering judgment section 33, and a control section 34. The control section 34 takes overall control of each component of the management server 12. The clock circuit 27 has a clock function and outputs data of year, month, date, and time.

The communication section 28 on the server side communicates with the external PC terminal 11 via the internet network 14 or with the mobile terminal 13. The recognition section 29 performs user authentication by matching the user ID and password input from the PC terminal 11 or the mobile terminal 13 with the user ID and password listed on a user management table which is preliminarily stored in the memory section 32.

The common key creating section 30 creates a common key, which is to be sent to the mobile terminal 13, for each inspection point selected by the mobile terminal 13. The common key created by the common key creating section 30 in addition to the image data, hash value, and inspection information file that are sent from the mobile terminal 13 are accumulated in association with each inspection point in the memory section 32. In the memory section 32, data of construction list, structure drawings and bar arrangement drawings which is sent to the mobile terminal 13 to specify the inspection point, the application program, and the like are also accumulated. The control section 34 includes an execution section for executing the application program.

When an acquisition of image data corresponding to a desired inspection point is requested from the PC terminal 11, the hashing section 31 merges the image data, inspection information file and common key associated with the inspection point, and performs calculation by the one-way hash function based on the merged result, and thereby creating a hash value at the time (current hash value). The tampering judgment section 33 compares the current hash value calculated by the hashing section 31 and the hash value stored in the memory section 32 (original hash value) to judge whether the image data has been tampered or not. When the current hash value and the original hash value matches, it is judged that there is no tampering, and allows the transmission of the image data.

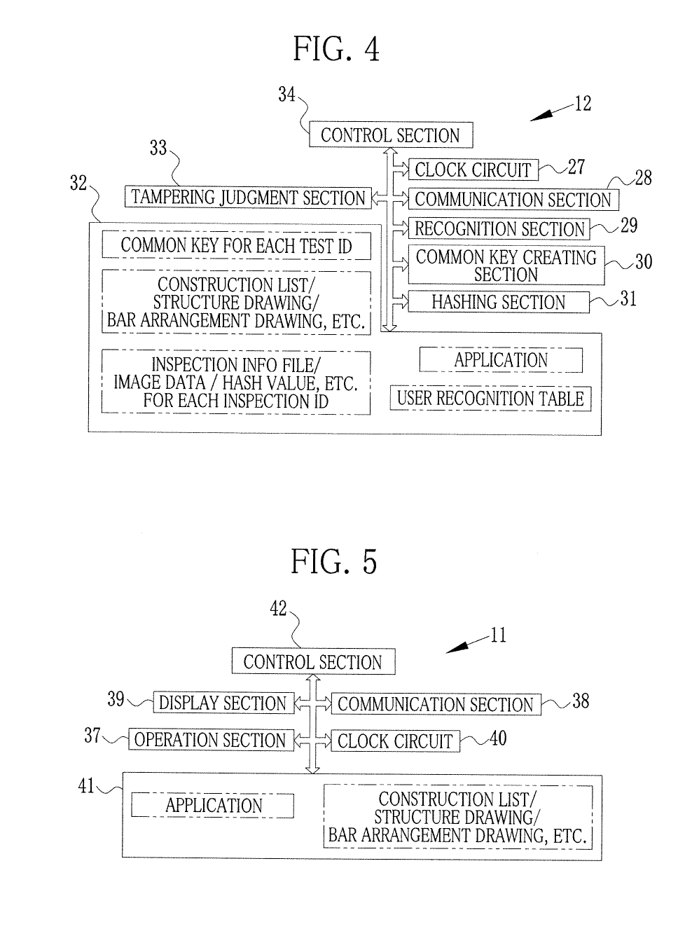

As shown in FIG. 5, the PC terminal 11 includes an operation section 37 including a keyboard, a mouse and the like, a communication section 38, a display section 39, a clock circuit 40, a memory section 41, and a control section 42. The control section 42 takes overall control of each component of the PC terminal 11. The PC terminal 11 is used for making the bar arrangement inspection report by a report writer (operator) different from the inspector who uses the mobile terminal 13. The communication section 38 is connected to the Internet network 14, and thereby communicating with the external management server 12. The clock circuit 40 has a clock function and outputs data of year, month, date, and time. In the memory section 41, the application program for producing the bar arrangement inspection report is stored. In addition, files of the bar arrangement inspection report made by the program, construction list, structure drawings and bar arrangement drawings, which are downloaded from the management server 12 in order to use for the program, the image data, and the like are stored in the memory section 41. The control section 42 has an execution section, a display control section, and the like. The execution section reads out and executes the above-described program in response to an instruction to execute the application program from the operation section 37, and the display control section displays the execution result on the display section 39.

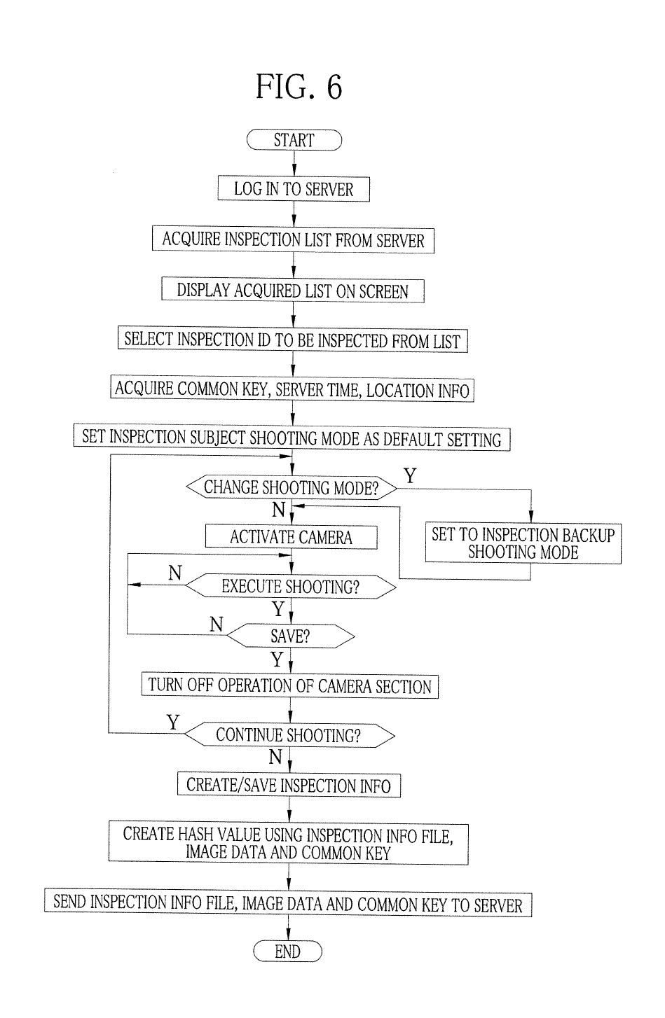

Hereinafter, an operation of the bar arrangement inspection system is explained. The inspector executes the bar arrangement inspection application by operating the mobile terminal 13 at the construction site. When the bar arrangement inspection application is executed, the mobile terminal 13 is connected to a login screen of the management server 12 by the recognition section as shown in FIG. 6. When the operator logs in by inputting the user ID and password on the login screen, the inspection list acquisition/select section requests the management server 12 for the list of the inspection points. The management server 12 sends the list for specifying the inspection point to the mobile terminal 13.

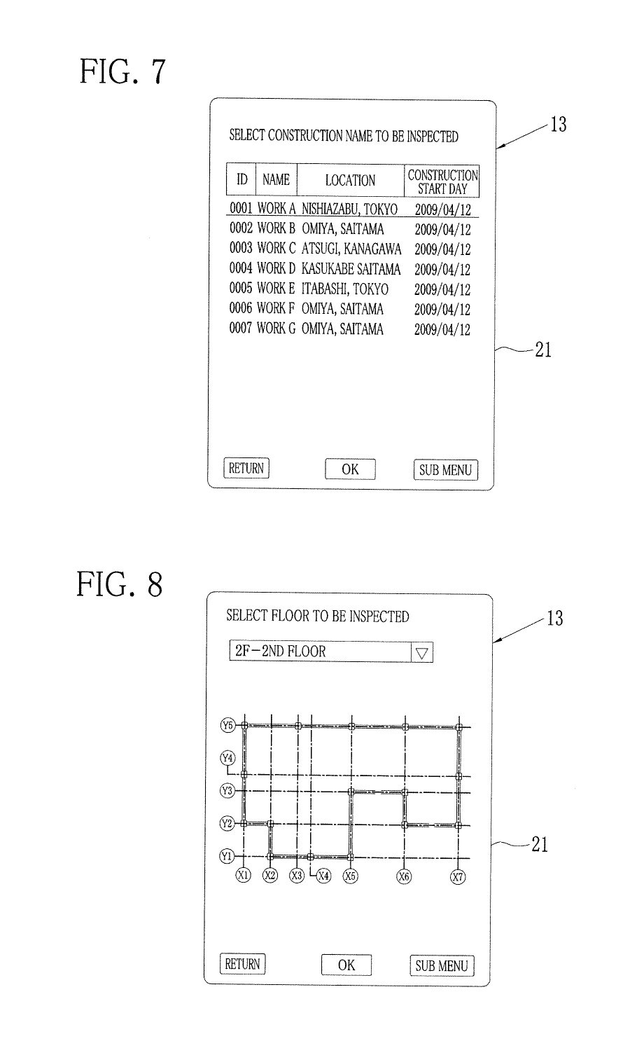

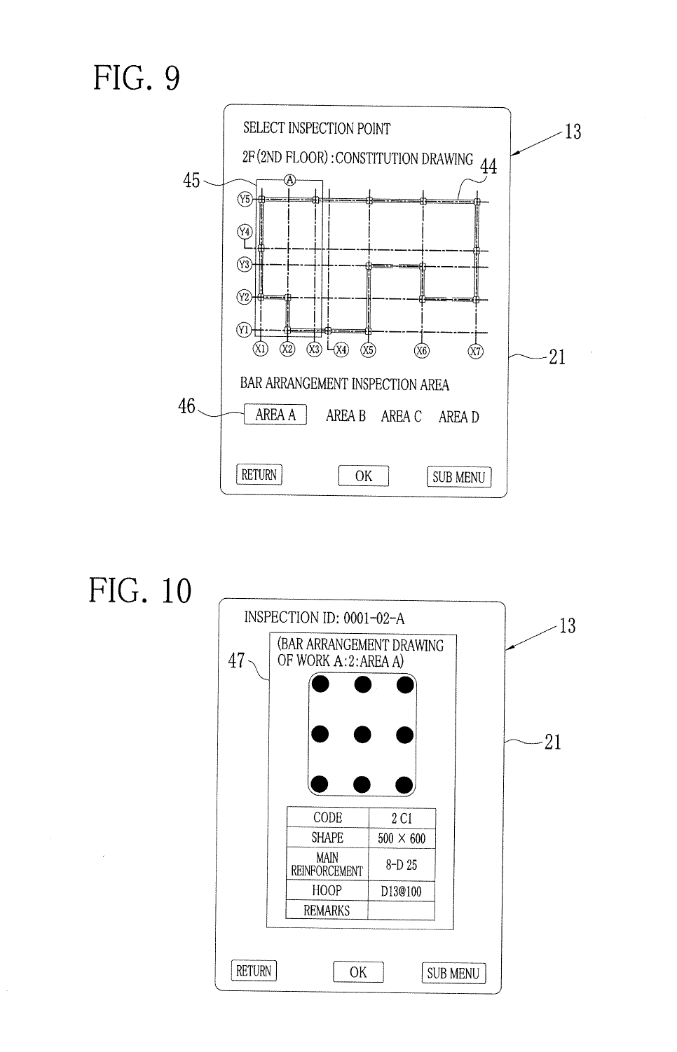

As shown in FIGS. 7 to 10, for example, the select operation of the inspection point with the mobile terminal 13 is made by narrowing down the selection from large classification to small classification. As the large classification, the construction list in which name, location, and start day of the construction are related with one another is displayed as shown in FIG. 7. The appropriate construction is selected from the list by operating the operation section 19. In the case where the constructing building has plural floors, screen data for selecting a floor is sent to and displayed on the display section 21 as shown in FIG. 8. When the floor is selected on this screen, data of an appropriate structure drawing 44 of the selected floor is sent to and displayed on the display section 21 as shown in FIG. 9. On the screen of the displayed section 21 shown in FIG. 9, an area to be inspected (hereinafter, referred to as inspection area) can be selected in the structure drawing 44 with a drawing select border 45. For example, the drawing select border 45 is moved by operating the arrow keys to one of the inspection areas preliminarily set in the structure drawing 44. In conjunction with the movement of the drawing select border 45, a name select border 46 is moved to the corresponding area name among areas A to D listed at the bottom of the display section 21.

When an “OK” button is operated after selecting the inspection area, the inspection point is confirmed, and this information is sent to the management server 12. The management server 12 sends data of bar arrangement drawing of this inspection point to the mobile terminal 13. The received bar arrangement drawing 47 is displayed on the display section 21 of the mobile terminal 13 as shown in FIG. 10. When the inspection point is selected in this manner, the inspection ID, such as “0001-02-A” corresponding to the inspection point sent from the management server 12 is displayed at the top of the display section 21.

When an “OK” button shown in FIG. 10 is operated after selecting the inspection point, the inspection point (hereinafter, referred to as “inspection ID”) is confirmed. After the inspection ID is confirmed, a common key request section of the bar arrangement inspection application requests the management server 12 for a common key. When the request is received, the management server 12 creates the common key in the common key creating section 30 and sends the created common key to the mobile terminal 13. In addition, the location information acquisition section acquires the location information and sends it to the management server 12. Such acquisition and transmission of the common key and the location information are processed in the background.

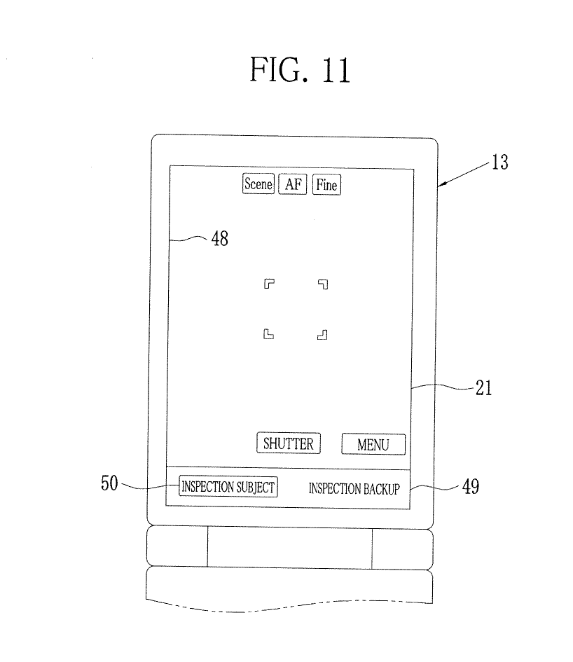

Thereafter, the image data acquisition section activates the camera section 23, and switches the display section 21 to a shooting screen as shown in FIG. 11. On this screen, a screen 48 for displaying a shooting area and a select screen 49 for switching the shooting mode between the inspection subject shooting mode and the inspection backup shooting mode are displayed. In the select screen 49, a select border 50 for selecting the mode is displayed. Since the inspection subject shooting mode is selected by default, the acquired image data under this setting is stored as the image data of the inspection subject picture in the memory section 24.

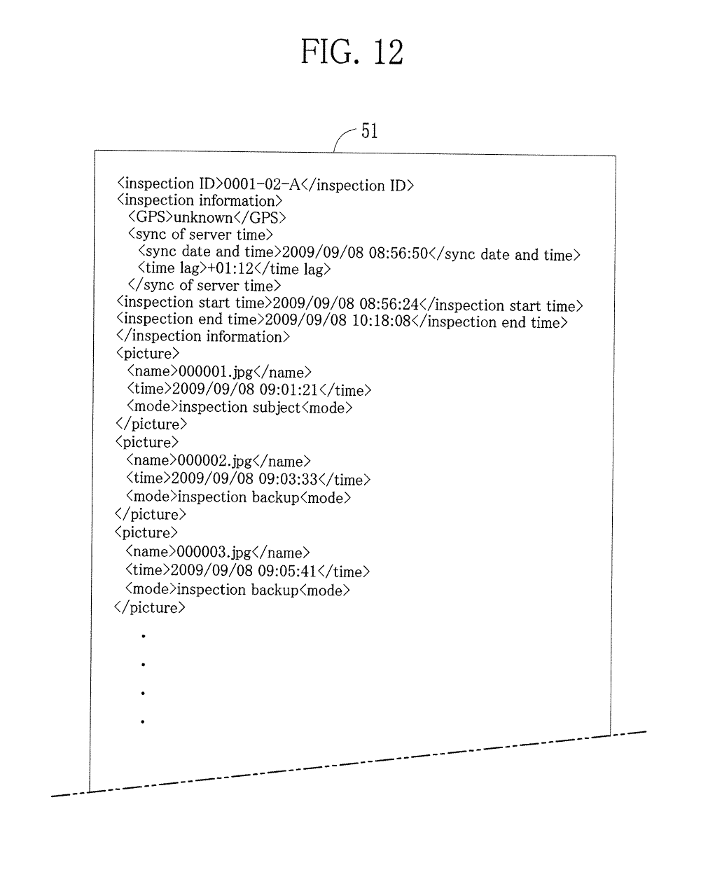

In this way, the image data is acquired after selecting one of the inspection subject shooting mode and the inspection backup shooting mode. When the shooting is completed by the operation, the operation of the camera section 23 is stopped. Once the operation of the camera section 23 stops, an inspection status file creating section creates an inspection information file 51 as shown in FIG. 12.

The inspection information file is a meta-information file recoding information about the inspection, and is used to associate a certificate which proves that the inspection has been conducted with the image data on the management server 12 side. The inspection information file 51 includes the inspection ID, GPS information, synchronized time with the management server, inspection start time, inspection end time, shooting date and file name of the inspection subject picture, and shooting date and file name of the inspection backup picture. The GPS information indicates the location information of the mobile terminal, and may be acquired at the time when logging in to the management server 12 or when creating the inspection information list. If the GPS information cannot be acquired, for example, “unknown” is recorded in a record column of the GPS information.

After the inspection information file 51 is created, the hashing section merges the image data, the inspection information file and the common key, and performs calculation by the one-way hash function based on the merged result, and thereby creating the hash value. Then, the transmission section sends the acquired image data, the inspection information file and the hash value all together to the management server 12. Note that the hash value is sent as a hash value information file to be associated with the inspection ID. After the transmission, the bar arrangement inspection of the selected inspection point is finished. It is possible to continuously perform the bar arrangement inspection of other inspection points. At this time, the above-described operations after logging in are repeated. When finishing the bar arrangement inspection, the bar arrangement inspection application is ended. Owing to this, the operator logs off of the management server 12.

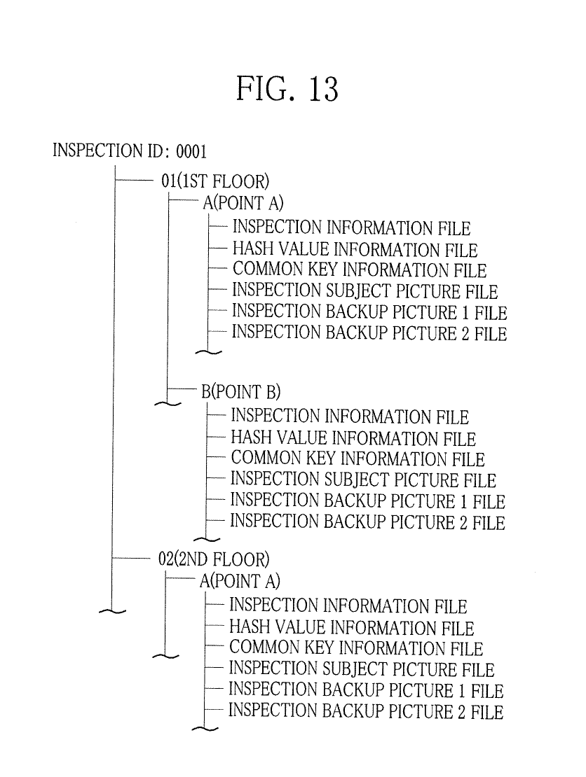

The image data, the inspection information file, and the hash value information file sent from the mobile terminal 13 are stored in association with the inspection ID in the memory section of the management server 12 as shown in FIG. 13. At this time, the common key information file in which the created common key is recorded is also stored in association with the inspection ID. Note that the image data, the inspection information file, the common key information file, and the hash value information file can be stored without being associated with one another. In this case, a crawler/indexer section is provided, and the crawler/indexer section cruises the inspection information file, the common key information file, and the hash value information file at regular time intervals and corrects information such as the inspection ID, the file name of the image data, the common key, the hash value, and the like as a search criteria and registers the corrected information in a database. For this configuration, the management server 12 can easily search the address and the hash value of the image data using the inspection ID as the search criteria.

The bar arrangement inspection report is made using the application program installed on the PC terminal 11. The report has a ledger sheet attached in which the bar arrangement drawing and the verification picture are associated with each other. At this time, the verification picture of the inspection point is downloaded by connecting to the management server 12.

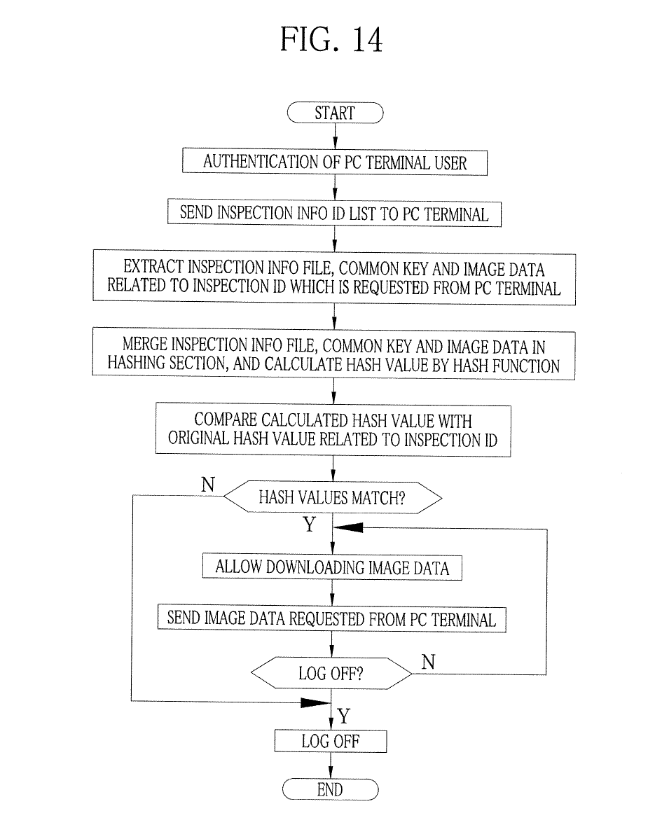

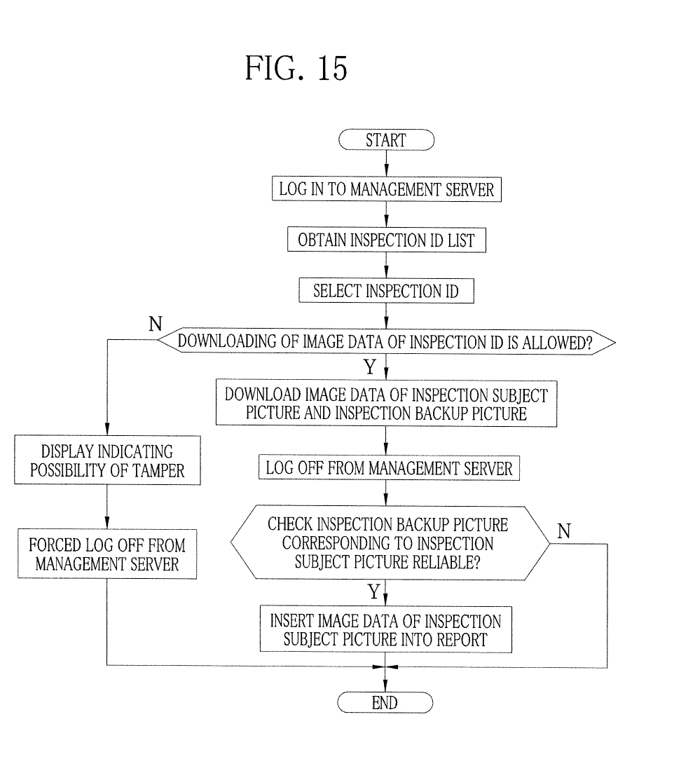

As shown in FIGS. 14 and 15, the PC terminal 11 is connected to the management server 12. The login screen is displayed on the display section 39 of the PC terminal 11. On the login screen, the user ID and the password is input to log in to the management server 12. When logging in to the management server 12, the inspection ID list is sent from the management server 12 to the PC terminal 11. The list is displayed on the display section 39 of the PC terminal 11. When the inspection ID is selected on the PC terminal 11 side, the request is sent to the management sever 12.

The management server 12 extracts the image data, the common key, and the inspection information file associated with the requested inspection ID. The extracted image data, the common key, and the inspection information file are sent to the hashing section 31. The hashing section 31 merges the image data, the inspection information file, and the common key, and performs calculation by the one-way hash function based on the merged result, and thereby creating the hash value. The calculated hash value is sent to the tempering judgment section 33. The tampering judgment section 33 compares the current hash value and the original has value stored in association with the inspection ID and judges whether the hash values match or not.

If the hash values match, that is, if it is judged that the image data is not tampered, the management server 12 allows the downloading request of the image data of the inspection subject picture and the image data of the inspection backup picture that are associated with the inspection ID from the PC terminal 11. If it is judged that the image data is tampered, a message indicating, for example, “Data may have been tampered” is displayed on the display section 39 of the PC terminal 11, and turns off the connection of the PC terminal 11.

When the downloading is allowed, the management server 12 sends the file name list of the image data of inspection subject picture and inspection backup picture, or a list of thumbnail images to the PC terminal 11. Those lists are displayed on the display section 39 of the PC terminal 11. To display the images, for example, the screen is divided into left frame and right frame, and the thumbnail image list of the image data of inspection subject pictures is displayed on the left side and the thumbnail image list of the image data of inspection backup pictures is displayed on the right side. For this configuration, the image data of the inspection backup picture used for confirming the authenticity of the image data of the inspection subject picture can be referred immediately, which facilitates the confirmation process.

When the image data of the necessary inspection subject picture is selected and stored on the PC terminal 11, the management server 12 sends the selected image data to the PC terminal 11. In this way, the image data of the necessary inspection subject picture is retrieved from the management server 12 and the report is made.

According to the above embodiment, although the common key is used for calculating the hash value in the mobile terminal and the management server, the common key can be omitted in the calculation.

In addition, according to the above embodiment, although the bar arrangement inspection system is explained, the present invention is not limited to this. Any inspection systems in which image data acquired with the mobile terminal is stored in the management server, and this image data is acquired by the PC terminal to perform the inspection can be applicable.

Various changes and modifications are possible in the present invention and may be understood to be within the present invention.

What is claimed is:

1. An inspection system comprising a mobile terminal having a photographing function, a management server for storing image data received from said mobile terminal via communication network, and a PC terminal which performs an inspection based on said image data acquired from said management server:
(A) said mobile terminal comprising:
an inspection identifying information acquisition section for acquiring inspection identifying information preliminarily determined for each inspection site;
an image data acquisition section for acquiring image data of inspection subject picture which is a picture of said inspection site corresponding to said inspection identifying information and image data of inspection backup picture which is a picture taken for backing up said inspection subject picture;
an inspection information creating section for creating inspection information which associates the image data of said inspection subject picture and the image data of said inspection backup picture with said inspection identifying information;
a hashing section for merging said inspection information, the image data of said inspection subject picture and the image data of said inspection backup picture, and calculating a first hash value by a hash function based on the merged result; and
a transmitting section for transmitting said first hash value, said inspection information, the image data of said inspection subject picture and the image data of said inspection backup picture to said management server,
(B) said management server comprising:
a storage section for storing said first hash value, said inspection information, the image data of said inspection subject picture and the image data of said inspection backup picture in association with said inspection identifying information;
a hash value calculating section, when said image data corresponding to said inspection identifying information is requested to be acquired from said PC terminal, said hash value calculating section merging said inspection information corresponding to said inspection identifying information, the image data of said inspection subject picture and the image data of said inspection backup picture, and calculating a second hash value by said hash function based on the merged result; and
a tampering judgment section for judging existence of tempering by comparing said second hash value with said first hash value, and allowing transmission of said image data when it is judged that there is no tampering, and
(C) said PC terminal comprising:
a display section for displaying the image data of said inspection subject picture and the image data of said inspection backup picture acquired from said management server.

2. The inspection system as defined in claim 1, wherein
said management server further includes a memory section for creating a common key for each said inspection identifying information, and storing the created common key in association with said inspection identifying information, and
said mobile terminal further includes a common key acquisition section for acquiring said common key corresponding to said inspection identifying information from said management server, wherein
said hashing section of said mobile terminal merges said inspection information including said common key, the image data of said inspection subject picture and the image data of said inspection backup picture, and calculates said first hash value by said hash function based on the merged result, and
said hash value calculating section of said management server merges said inspection information including said common key, the image data of said inspection subject picture and the image data of said inspection backup picture, and calculates said second hash value by said hash function based on the merged result.

3. An inspection method in which a PC terminal performs an inspection by using image data acquired from a management server, said image data being transmitted from a mobile terminal to said management server via communication network, said inspection method comprising the steps of:
acquiring inspection identifying information preliminarily determined for each inspection site using said mobile terminal from said management server:
acquiring image data of inspection subject picture which is a picture of said inspection site corresponding to said inspection identifying information and image data of inspection backup picture which is a picture taken for backing up said inspection subject picture using said mobile terminal;
creating inspection information which associates the image data of said inspection subject picture and the image data of said inspection backup picture with said inspection identifying information using said mobile terminal;
merging said inspection information, the image data of said inspection subject picture and the image data of said inspection backup picture, and calculating a first hash value by a hash function based on the merged result using said mobile terminal;
transmitting said first hash value, said inspection information, the image data of said inspection subject picture and the image data of said inspection backup picture to said management server using said mobile terminal;
storing said first hash value, said inspection information, the image data of said inspection subject picture and the image data of said inspection backup picture in association with said inspection identifying information using said management server;
merging said inspection information corresponding to said inspection identifying information, the image data of said inspection subject picture and the image data of said inspection backup picture, and calculating a second hash value by said hash function based on the merged result using said management server when said image data corresponding to said inspection identifying information is requested to be acquired from said PC terminal;
judging existence of tempering by comparing said second hash value with said first hash value, and allowing transmission of said image data when it is judged that there is no tampering using said management server; and
displaying the image data of said inspection subject picture and the image data of said inspection backup picture acquired from said management server using said PC terminal.

4. A management server which stores image data received from a mobile terminal via communication network in association with inspection identifying information preliminarily determined for each inspection site and transmits the stored image data to a PC terminal, said management server comprising:
a transmitting section for transmitting said inspection identifying information upon request from said mobile terminal;
a receiving section for receiving image data of inspection subject picture which is a picture of said inspection site corresponding to said inspection identifying information, image data of inspection backup picture which is a picture taken for backing up said inspection subject picture, inspection information which associates the image data of said inspection subject picture and the image data of said inspection backup picture with said inspection identifying information, and a first hash value calculated by a hash function based on the merged result obtained by merging said inspection information, the image data of said inspection subject picture and the image data of said inspection backup picture from said mobile terminal;
a storage section for storing said first hash value, said inspection information, the image data of said inspection subject picture and the image data of said inspection backup picture in association with said inspection identifying information;
a hash value calculating section, when said image data corresponding to said inspection identifying information is requested to be acquired from said PC terminal, said hash value calculating section merging said inspection information corresponding to said inspection identifying information, the image data of said inspection subject picture and the image data of said inspection backup picture, and calculating a second hash value by said hash function based on the merged result; and
a tampering judgment section for judging existence of tempering by comparing said second hash value with said first hash value, and allowing transmission of said image data when it is judged that there is no tampering.

5. A mobile terminal which has a photographing function and a communication function and is connected to an external management server via communication network, comprising:
a memory section for preliminarily storing connection destination information of said management server;
a communication section which is connected to said management server via said communication network;
an identifying information acquisition section for acquiring inspection identifying information corresponding to an inspection site from said management server;
an image data acquisition section for acquiring image data of inspection subject picture which is a picture of said inspection site corresponding to said inspection identifying information and image data of inspection backup picture which is a picture taken for backing up said inspection subject picture by activating said photographing function;
an inspection information creating section for creating inspection information which associates the image data of said inspection subject picture and the image data of said inspection backup picture with said inspection identifying information;
a hashing section for merging said inspection information, the image data of said inspection subject picture and the image data of said inspection backup picture, and calculating a hash value by a hash function based on the merged result; and
a transmitting section for transmitting said hash value, said inspection information, the image data of said inspection subject picture and the image data of said inspection backup picture all together to said management server.

6. The mobile terminal as defined in claim 5, wherein said mobile terminal further includes a common key acquisition section for acquiring a common key which is created for each said inspection identifying information by said management server, wherein
said hashing section merges said inspection information including said common key, the image data of said inspection subject picture and the image data of said inspection backup picture, and calculates said hash value by said hash function based on the merged result.

7. An inspection program which makes a mobile terminal perform the functions of:
a communication section which is connected to a management server via communication network;
an identifying information acquisition section for acquiring inspection identifying information corresponding to an inspection site from said management server;
an image data acquisition section for acquiring image data of inspection subject picture which is a picture of said inspection site corresponding to said inspection identifying information and image data of inspection backup picture which is a picture taken for backing up said inspection subject picture by activating a photographing function;
an inspection information creating section for creating inspection information which associates the image data of said inspection subject picture and the image data of said inspection backup picture with said inspection identifying information;
a hashing section for merging said inspection information, the image data of said inspection subject picture and the image data of said inspection backup picture, and calculating a hash value by a hash function based on the merged result; and
a transmitting section for transmitting said hash value, said inspection information, the image data of said inspection subject picture and the image data of said inspection backup picture all together to said management server.

8. A computer-readable memory medium which stores the inspection program as defined in claim 7.

9. An inspection program which makes a computer perform the functions of:
a communication section which is connected to a management server via communication network;
an identifying information acquisition section for acquiring inspection identifying information corresponding to an inspection site from said management server;
a common key acquisition section for acquiring a common key corresponding to said inspection identifying information from said management server;
an image data acquisition section for acquiring image data of inspection subject picture which is a picture of said inspection site corresponding to said inspection identifying information and image data of inspection backup picture which is a picture taken for backing up said inspection subject picture by activating a photographing function;
a hashing section for merging said common key, said inspection information, the image data of said inspection subject picture and the image data of said inspection backup picture, and calculating a hash value by a hash function based on the merged result; and
a transmitting section for transmitting said hash value, said inspection information, the image data of said inspection subject picture and the image data of said inspection backup picture all together to said management server.

10. A computer-readable memory medium which stores the inspection program as defined in claim 9.
